(19) United States
(12) Patent Application Publication
(10) Pub. No.: US 2004/0229485 A1
(43) Pub. Date: Nov. 18, 2004

(54) Electrical connector locking lever

(75) Inventors: Sylvain Cloarec, Fontenay Le Fleury (FR); Julien Larde, La Boissiere Ecole (FR)

Correspondence Address: GREENBLUM & BERNSTEIN, P.L.C., 1950 ROLAND CLARKE PLACE, RESTON, VA, 20191, US

(73) Assignee: CONNECTEURS CINCH, Montigny Le Bretoneux (FR)

(21) Appl. No.: 10/796,024

(22) Filed: Mar. 10, 2004

(30) Foreign Application Priority Data
Mar. 11, 2003 (FR) 03.02994

(51) Int. Cl. H01R 13/62

(52) U.S. Cl. 439/157

(57) ABSTRACT

Combination of a locking lever and a connector of the type utilizing a female housing member and a male housing member, wherein one of the male and female housing members includes studs arranged on two opposite walls, and wherein the locking lever is a U-shaped member that has two flanges and a holding strip portion. The U-shaped member is mounted in an articulated manner on two corresponding walls of another of the male and female housing members. Each of the two flanges has a cam adapted to cooperate with one of the studs. The locking lever is movable at least between a rest position and a locking position. This Abstract is not intended to define the invention disclosed in the specification, nor intended to limit the scope of the invention in any way.

### CROSS-REFERENCE TO RELATED APPLICATION

The present application claims priority under 35 U.S.C. § 119 of French Patent Application No. 03 02994 filed Mar. 11, 2003, the disclosure of which is hereby expressly incorporated by reference in its entirety.

### BACKGROUND OF THE INVENTION

1. Field of the Invention

The present invention relates to an electrical connector locking lever.

The invention also relates to connectors including a female housing member and a male housing member. One of the two members have flanges of a locking lever articulated to two opposite walls. The other member has studs on the corresponding walls adapted to cooperate with cams on the flanges.

2. Description of the Prior Art

Connectors of the above kind have the advantage of allowing effortless insertion of male electrical contact tongues of one of the housing members into female electrical contact members of the other housing member when there is a large number of contacts.

When making the electrical connection on a vehicle, operators have to lock a large number of connectors, this involving each time pivoting the lever from a rest position, in which the male housing member can be inserted into the female housing member, to a locking position. A repetitive operation of this kind is tiring and, in the long term, can lead to irritation of the fingers or even injuries.

### SUMMARY OF THE INVENTION

The present invention aims to remedy this drawback.

The invention provides for a locking lever for a connector of the type which includes a female housing member and a male housing member. One of the two members has studs on two opposite walls. The other member has a locking lever that is U-shaped with two flanges and a holding strip articulated on two corresponding walls. Each of the flanges has a cam adapted to cooperate with a corresponding stud. The lever is adapted to occupy a rest position in which the cams are moved away from the studs to allow insertion of the male member into the female member, and after pivoting the lever, a locking position in which the studs cooperate with the cams. The housing member to which the lever is articulated has an abutment against which an edge of the holding strip bears, while the opposite edge has a projection adapted to cooperate with a lug of an elastic locking tab. The holding strip has in the vicinity of each flange a notch of circular arc shape that is inclined so that the end of the notch adjacent to the edge of the holding strip having the projection is lower than the adjoining end of the edge of the holding strip adapted to bear against the abutment.

Thanks to the above feature, the lever has specific locations for the fingers, which facilitates the work of the operator and prevents irritation of the fingers.

The invention is described in more detail next with reference to one particular embodiment shown by way of example only in the appended drawings.

The invention also provides for the combination of a locking lever and a connector of the type comprising a female housing member and a male housing member, wherein one of the male and female housing members includes studs arranged on two opposite walls, wherein the locking lever is a U-shaped member that comprises two flanges and a holding strip portion. The U-shaped member is mounted in an articulated manner on two corresponding walls of another of the male and female housing members. Each of the two flanges has a cam adapted to cooperate with one of the studs. The locking lever is movable at least between a rest position in which the cams are positioned away from said studs to allow insertion of the male housing member into the female housing member and a locking position in which said studs cooperate with said cams. One of the male and female housing members to which the locking lever is mounted has an abutment. A first edge of the holding strip portion is adapted to bear against the abutment. A second opposite edge of the holding strip portion has a projection adapted to cooperate with a lug of an elastic locking tab. The holding strip portion comprises, in the vicinity of each of the two flanges, at least one notch of circular arc shape. Each at least one notch is inclined so that an end adjacent to the second opposite edge is lower than an end adjacent to the first edge of the holding strip portion.

The invention also provides for a method of locking together a male housing member and a female housing member using the combination described above, wherein the method comprises moving the male housing member into engagement with the female housing member, pivoting the locking lever towards the locking position whereby the cams engage with the studs and locking the locking lever in the locking position.

The invention also provides for an electrical connector connecting system comprising a connector arrangement comprising a first housing member and a second housing member. The second housing member comprises studs arranged on two opposite walls. A locking lever comprises a U-shaped member that includes two flanges and a holding strip portion. The locking lever is movably mounted to two walls of the first housing member. Each of the two flanges has a cam surface adapted to engage with one of the studs. The locking lever is movable at least between a first position wherein the cam surfaces are disengaged from the studs to allow insertion of the first housing member into the second housing member and a locking position in which said studs engage with said cam surfaces. An abutment is provided. A first edge of the holding strip portion is adapted to bear against the abutment. A locking arrangement is adapted to lock the locking lever in the locking position.

The holding strip portion may comprise, in the vicinity of each of the two flanges, at least one notch of circular arc shape. Each at least one notch may be inclined so that an end adjacent to the second opposite edge is lower than an end adjacent to the first edge of the holding strip portion. The locking arrangement may comprise a projection arranged on a second opposite edge of the holding strip portion and a cooperating lug. The cooperating lug may be arranged on an elastic locking tab. The first housing member may comprise a male housing member. The second housing member may comprise a female housing member. The two opposite walls may be parallel to one another. Each of the studs may comprise a head which is at least one of partially circular and partially curved. The two flanges may be parallel to one another. The two walls of the first housing member may be parallel to one another. Each cam surface may comprise one of a curved surface and a convex surface.

The abutment may be arranged on the first housing member. The system may further comprise a second locking arrangement adapted to lock the locking lever in the first position. The second locking arrangement may comprise at least one boss arranged on one of the two flanges and at least one recess arranged on one of the first housing member.

Each of the two flanges may further comprise an opening adapted to engage with one of the studs.

The invention also provides for a method of locking together a first housing member and a second housing member using the system described above wherein the method comprises moving the first housing member into engagement with the second housing member, pivoting the locking lever towards the locking position whereby each cam surfaces engage with one of the studs, and locking the locking lever in the locking position with the locking arrangement.

The invention also provides for locking lever for a connector arrangement, the locking lever comprising a U-shaped member that comprises two flanges and a holding strip portion. The U-shaped member comprises oppositely arranged openings adapted to receive therein journals, whereby the U-shaped member can be amounted in an articulated manner on said journals. Each of the two flanges having a cam surface adapted to cooperate with studs. A first edge of the holding strip portion is adapted to bear against an abutment of the connector arrangement. A second opposite edge of the holding strip portion has a projection adapted to cooperate with a lug of an elastic locking tab of the connector arrangement. The holding strip portion comprises, in the vicinity of each of the two flanges, at least one notch of circular arc shape. Each at least one notch is inclined so that an end adjacent to the second opposite edge is lower than an end adjacent to the first edge of the holding strip portion.

### BRIEF DESCRIPTION OF THE DRAWINGS

The present invention is further described in the detailed description which follows, in reference to the noted plurality of drawings wherein:

FIG. 1 is a perspective view of a connector incorporating a locking lever according to the invention; and

FIG. 2 is a perspective view of the locking lever.

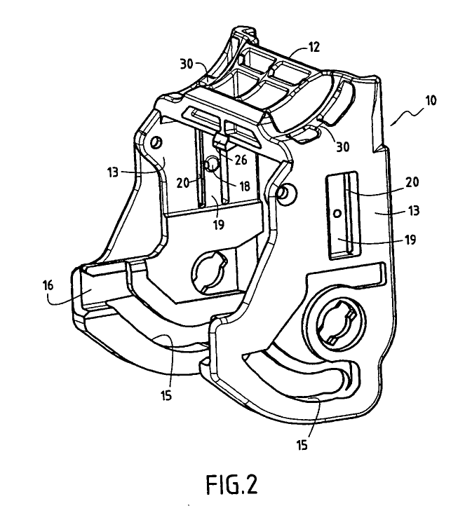

### DETAILED DESCRIPTION OF THE PRESENT INVENTION

The connector shown in the figures comprises a base 1 with female members 2 adapted to receive male members 3.

Each female member 2 has pins (not shown) on its bottom adapted to cooperate with female electrical contact members accommodated in passages in the male member 3.

Each female member 2 also has a stud 5 with a head 6 arranged on each of two opposite walls 2a.

The male member 3 has one end 8 adapted to be inserted into the corresponding female member and journals 11 on which a locking lever 10 pivots on each of two opposite walls 3a.

In the figures, the lever 10 is shown to be connected in an articulated manner to the male member. However, the invention also contemplates mounting the lever in an articulated manner to the female member 2. In this case, of course, the male member 3 would include the studs 5 instead of the female member 2.

The locking lever 10 is U-shaped and includes a holding strip portion 12 and two flanges 13 extending therefrom. Each flange 13 has in the vicinity of its free end a cam 15 and an opening 16 at one end.

In the vicinity of the strip 12, each flange 13 has a boss 18 arranged on an inside face of each flange 13. Each boss 18 is mounted on a thin strip portion 19. Two slots 20 are arranged on respective opposite sides of each strip 19 in order to increase an elasticity of the strip 19.

Two cavities 17 arranged on the male member 3 receive the bosses 18 when the locking lever 10 is in the rest position.

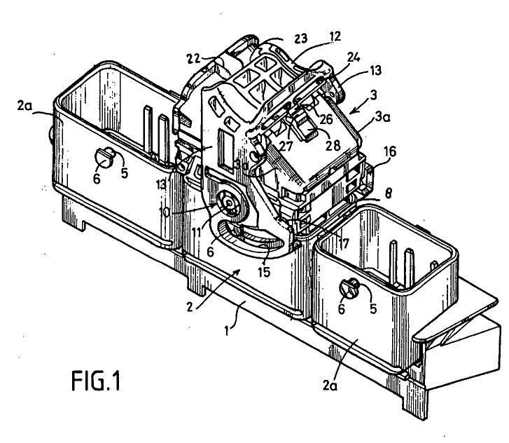

The male member 3 also includes an abutment 22 against which bears an edge 23 of the holding strip 12. This occurs in the locking position shown in FIG. 1. A latch is also provided for immobilizing the lever 10 in the locking position. The latch includes a projection 26 which is arranged on an edge 24 of the holding strip 12 and a lug 27 which is arranged on an elastic locking tab 28.

When the lever 10 is pivoted toward the rest position, in which the bosses 18 cooperate with and/or become positioned within the cavities 17, the male housing member 3 may easily be inserted into the female member 2. Thereafter, the lever 10 can be pivoted toward the locking position in order to cause the male member to be fully engaged and/or inserted into and/or with the female member 2.

The elastic locking tab 28 can be formed by providing a cut-out in the lateral wall in the body of the male member 3.

The holding strip 12 has in the vicinity of each of the flanges 13 two lateral notches 30 which are of circular and/or arc-shape. These notches 13 are arranged on surfaces which rise from the edge with the projection 26 to the opposite edge.

By utilizing the invention, an operator can simply place a hand at the end of the edge of the holding strip 12, i.e., the end adapted to cooperate with the abutment 22. With two fingers placed in the notches 30, the lever 10 can be closed more easily. In this way, a large number of levers 10 can be closed without fatigue and without risk of injury to the fingers of the operator.

Of course, the invention is not limited to the embodiment that has just been described and shown. Many modifications of detail may be made thereto without this departing from the scope of the invention.

1. (canceled).

2. The combination of a locking lever and a connector of the type comprising a female housing member and a male housing member, wherein one of the male and female housing members includes studs arranged on two opposite walls, wherein:
the locking lever is a U-shaped member that comprises two flanges and a holding strip portion;
the U-shaped member being mounted in an articulated manner on two corresponding walls of another of the male and female housing members;
each of the two flanges having a cam adapted to cooperate with one of the studs;
the locking lever being movable at least between a rest position in which the cams are positioned away from said studs to allow insertion of the male housing member into the female housing member and a locking position in which said studs cooperate with said cams;
one of the male and female housing members to which the locking lever is mounted having an abutment;
a first edge of the holding strip portion being adapted to bear against the abutment;
a second opposite edge of the holding strip portion having a projection adapted to cooperate with a lug of an elastic locking tab;
the holding strip portion comprising, in the vicinity of each of the two flanges, at least one notch of circular arc shape;
each at least one notch being inclined so that an end adjacent to the second opposite edge is lower than an end adjacent to the first edge of the holding strip portion.

3. An electrical connector connecting system comprising:
a connector arrangement comprising a first housing member and a second housing member;
the second housing member comprising studs arranged on two opposite walls;
a locking lever comprising a U-shaped member that includes two flanges and a holding strip portion;
the locking lever being movably mounted to two walls of the first housing member;
each of the two flanges having a cam surface adapted to engage with one of the studs;
the locking lever being movable at least between a first position wherein the cam surfaces are disengaged from the studs to allow insertion of the first housing member into the second housing member and a locking position in which said studs engage with said cam surfaces;
an abutment;
a first edge of the holding strip portion being adapted to bear against the abutment; and
a locking arrangement adapted to lock the locking lever in the locking position.

4. The system of claim 3, wherein the holding strip portion comprises, in the vicinity of each of the two flanges, at least one notch of circular arc shape.

5. The system of claim 4, wherein each at least one notch is inclined so that an end adjacent to the second opposite edge is lower than an end adjacent to the first edge of the holding strip portion.

6. The system of claim 3, wherein the locking arrangement comprises a projection arranged on a second opposite edge of the holding strip portion and a cooperating lug.

7. The system of claim 6, wherein the cooperating lug is arranged on an elastic locking tab.

8. The system of claim 3, wherein the first housing member comprises a male housing member.

9. The system of claim 3, wherein the second housing member comprises a female housing member.

10. The system of claim 3, wherein the two opposite walls are parallel to one another.

11. The system of claim 3, wherein each of the studs comprises a head which is at least one of partially circular and partially curved.

12. The system of claim 3, wherein the two flanges are parallel to one another.

13. The system of claim 3, wherein the two walls of the first housing member are parallel to one another.

14. The system of claim 3, wherein each cam surface comprises one of a curved surface and a convex surface.

15. The system of claim 3, wherein the abutment is arranged on the first housing member.

16. The system of claim 3, further comprising a second locking arrangement adapted to lock the locking lever in the first position.

17. The system of claim 16, wherein the second locking arrangement comprises at least one boss arranged on one of the two flanges and at least one recess arranged on one of the first housing member.

18. The system of claim 3, wherein each of the two flanges further comprises an opening adapted to engage with one of the studs.

19. A method of locking together a first housing member and a second housing member using the system of claim 3, the method comprising:
moving the first housing member into engagement with the second housing member;
pivoting the locking lever towards the locking position whereby each cam surfaces engage with one of the studs; and
locking the locking lever in the locking position with the locking arrangement.

20. A method of locking together a male housing member and a female housing member using the combination of claim 2, the method comprising:
moving the male housing member into engagement with the female housing member;
pivoting the locking lever towards the locking position whereby the cams engage with the studs; and
locking the locking lever in the locking position.

21. A locking lever for a connector arrangement, the locking lever comprising:
a U-shaped member that comprises two flanges and a holding strip portion;
the U-shaped member comprising oppositely arranged openings adapted to receive therein journals, whereby the U-shaped member can be mounted in an articulated manner on said journals;
each of the two flanges having a cam surface adapted to cooperate with studs;
a first edge of the holding strip portion being adapted to bear against an abutment of the connector arrangement;
a second opposite edge of the holding strip portion having a projection adapted to cooperate with a lug of an elastic locking tab of the connector arrangement;
the holding strip portion comprising, in the vicinity of each of the two flanges, at least one notch of circular arc shape; and
each at least one notch being inclined so that an end adjacent to the second opposite edge is lower than an end adjacent to the first edge of the holding strip portion.
